(19) United States
(12) Patent Application Publication
(10) Pub. No.: US 2011/0033342 A1
(43) Pub. Date: Feb. 10, 2011

(54) Hydrogen Generator and Fuel Pellet

(75) Inventors: Toshio Horiguchi, Tokyo (JP); Michael Miller, Hampshire (GB); John Tilston, Hampshire (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: QINETIQ LIMITED

(21) Appl. No.: 12/865,467

(22) PCT Filed: Nov. 7, 2008
(86) PCT No.: PCT/JP2008/070347

§ 371 Date: Oct. 7, 2010

(30) Foreign Application Priority Data
Feb. 1, 2008 (JP) 2008-023203

(51) Int. Cl. B01J 3/00; B01J 19/00; G05B 1/00

(52) U.S. Cl. 422/105; 422/222; 422/129; 422/119

(57) ABSTRACT

A hydrogen generator comprising a plurality of a fuel pellets (10) containing a hydrogen-generating compound such as ammonia borane, a case serving as a pressure-resistant container for containing the fuel pellets, and a controller for controlling hydrogen generation from the fuel pellets. This hydrogen generator generates hydrogen from the hydrogen-generating compound by a chemical reaction. The periphery of the fuel pellet is surrounded by a member including a thin plate of metal aluminum such as aluminum foil (18) on its surface.

### TECHNICAL FIELD

The present invention relates to a hydrogen generator which supplies hydrogen gas to a hydrogen-fuel cell for generating electric energy, and a fuel pellet body used for the same.

### BACKGROUND ART

Portable information devices such as a cellular phone, a PDA and a digital camera has mainly used a rechargeable secondary battery like a lithium ion battery, as its power source. In recent years, along with a demand of high functions, multifunctions, speedup and a long driving time for these devices, a small-sized fuel cell is expected as a new power source, and production of a prototype or experimental use partially starts.

The fuel cell is different from a conventional secondary battery, does not need a charging operation, and enables the devices to be operated for a long period of time only by replenishing the fuel or replacing a fuel cartridge. Among these fuel cells, a hydrogen-fuel cell using hydrogen as fuel can raise its power density due to its characteristics, and has been contemplated to be applied to the portable information devices or the like as a fuel cell which can cope with some degree of peak load as well like conventional secondary batteries. In the case of the portable information devices, in particular, it is a key how compact and how light is the size and weight of a hydrogen-storing device.

U.S. Patent Application Publication No. 2005/0227136 proposes a hydrogen fuel cell which is used after its tank constituted by a hydrogen storage alloy is filled with hydrogen. However, the hydrogen storage alloy is heavy in weight, is also large in size, and accordingly is not suitable for the portable information devices. In addition, when hydrogen which has been absorbed in the hydrogen storage alloy is used up, it is necessary to fill the tank with hydrogen by some method again. Accordingly, there is a problem that an infrastructure for the refilling must be prepared.

In order to solve these problems associated with the hydrogen storage alloy, WO02/18267 proposes a hydrogen generator which thermally decomposes a material such as ammonia borane containing much hydrogen to generate hydrogen. According to this method, hydrogen is generated from a solid fuel, so, it is not necessary to newly prepare a heavy and large tank of the hydrogen storage alloy and the infrastructure for filling the hydrogen storage alloy with gaseous hydrogen.

However, a physical structure of the hydrogen generator described in the above described international application can be applied to a general use such as a transportable generator which can be used in the outdoor, but cannot be applied to a very small-sized hydrogen generator. In the portable information devices such as the digital camera and the PDA, it is desired that the hydrogen generator has a size and a shape equal to the size and the shape of a current primary battery or secondary battery (18650 sizes (approximately 18 mm in diameter × approximately 65 mm in height), for instance). It is impossible for the structure of the above described hydrogen generator to be formed in such a size and a shape.

In addition, the above described international application does not specify various conditions for efficiently generating hydrogen in the hydrogen generator for the above described portable information devices, for instance, the specific size of ammonia borane, the environmental condition of its periphery and the like, and therefore it is impossible to realize an actual hydrogen generator.

### DISCLOSURE OF THE INVENTION

The present invention is made in view of the above described points and therefore an object of the present invention is to provide a hydrogen generator which can efficiently generate hydrogen from a hydrogen generating compound such as ammonia borane even though the hydrogen generator is small, and can enhance the electrical power output per unit volume of a connected hydrogen-fuel cell, and a fuel pellet body used for the same.

According to one aspect of the present invention, it provides a hydrogen generator for generating hydrogen from a hydrogen generating compound by a chemical reaction, comprises:

a plurality of fuel pellets including the hydrogen generating compound;

a pressure-resistant container for storing the plurality of the fuel pellets; and

a controller for controlling hydrogen generation from the fuel pellets, wherein

the periphery of the fuel pellet is enclosed with a member including a thin plate of metal aluminum on its surface.

In addition, according to another aspect of the present invention, it provides a fuel pellet body stored in a pressure-resistant container in a hydrogen generator for generating hydrogen from a hydrogen generating compound by a chemical reaction, comprises:

a hydrogen generating compound compacted into a cylindrical shape; and

a member including a thin plate of metal aluminum on its surface to enclose the periphery of the hydrogen generating compound.

### BRIEF DESCRIPTION OF THE DRAWINGS

FIG. 1A is a view illustrating a structure of a fuel pellet;

FIG. 1B is a view of the fuel pellet body according to the first embodiment of the present invention, which is viewed from the upper surface;

FIG. 2 is a view illustrating a structure of a hydrogen generator according to the first embodiment of the present invention;

FIG. 3 is a block diagram of a controller which is mounted on an electric substrate;

FIG. 4 is a view illustrating a flow chart of an operating sequence of a microcontroller;

FIG. 5A is a view illustrating a sectional structure of a fuel-pellet-holding unit of a hydrogen generator according to a second embodiment of the present invention; and

FIG. 5B is a perspective view of the pellet-holding unit.

### BEST MODE FOR CARRYING OUT THE INVENTION

The best mode for carrying out the present invention will be described below with reference to the drawings.

### First Embodiment

Before a hydrogen generator according to a first embodiment of the present invention will be described, a principle of hydrogen generation will be described below.

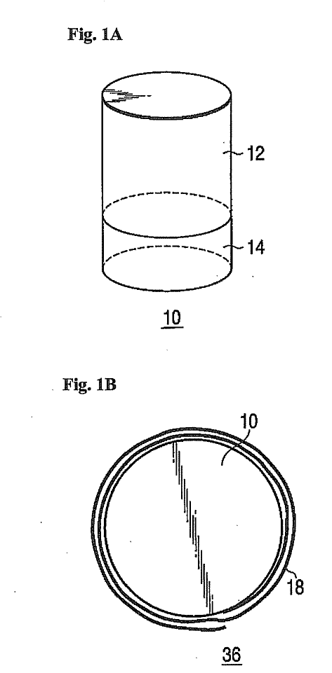

As is illustrated in FIG. 1A, a fuel pellet 10 is composed of an ammonia borane (NH₃BH₃) 12 which is a hydrogen generating compound, and a heat mix 14 for heating the ammonia borane 12. These ammonia borane 12 and heat mix 14 are compacted into predetermined shapes, here, cylindrical shapes, by respectively applied suitable pressures. The fuel pellet 10 is constructed by further applying a pressure to the ammonia borane 12 and the heat mix 14 so as to form an integral product.

Here, the ammonia borane 12 and the heat mix 14 will be described below.

The ammonia borane 12 contains approximately 20% hydrogen by a mass ratio, is a solid at normal temperature, has no explosibility, is a stable hydrogen source, and generates hydrogen by its thermal decomposition. The ammonia borane 12 contains twice more mass of hydrogen than liquid hydrogen with the same volume. The ammonia borane 12 is a material usually in a powder form, but can be pressed into a hard pellet shape, a rod shape, a conical shape or the like by being pressurized as needed.

This ammonia borane 12 is thermally decomposed in three stages by the elevation of temperature and generates hydrogen. Specifically, the ammonia borane 12 melts at approximately 100° C. to become a liquid when having been heated, and then generates one molecule of hydrogen. The reaction formula at this time is expressed by the following expression (1), and this is a hydrogen-generating reaction in the first stage.

NH₃BH₃→NH₂BH₂+H₂ (1)

This reaction is an exothermic reaction, and by this reaction heat, the ammonia borane 12 itself raises its temperature to progress the hydrogen-generating reaction to the second stage. In other words, the reaction heat further raises the temperature of NH₂BH₂ generated in the above described hydrogen-generating reaction in the first stage, and NH₂BH₂ generates one molecule of hydrogen at approximately 150° C. The reaction formula at this time is expressed by the following expression (2), and this is a hydrogen-generating reaction in the second stage.

NH₂BH₂→NHBH+H₂ (2)

This reaction is also an exothermic reaction, and theoretically generates such a heat as to raise the temperature of NHBH to such a temperature that the NHBH can be thermally decomposed in the third stage. When the temperature exceeds approximately 480° C., the remaining NIGH generates the last one molecule of the hydrogen. The reaction formula at this time is expressed by the following expression (3), and this is a hydrogen-generating reaction in the third stage.

NHBH→BN+H₂ (3)

The hydrogen-generating reaction in this third stage also theoretically generates such a sufficient heat as to completely thermally decompose NHBH.

Thus, the ammonia borane 12 generates three molecules of hydrogen from one molecular thereof by being heated.

On the other hand, the above described heat mix 14 is a mixture of lithium aluminum hydride (LiAlH₄) and ammonium chloride (NH₄Cl). When a small amount of heat is given to the mixture by a heater or the like from the outside, the mixture becomes a heat source which generates heat by itself, and heats the above described ammonia borane 12. In addition, the heat mix 14 not only works as a heat source, but also generates a small amount of hydrogen as illustrated in the following expression (4).

LiAlH₄+NH₄Cl→LiCl+AlN+4H₂ (4)

However, the above described heat mix 14 is not limited to such a mixture of LiAlH₄ and NH₄C1, but may be any compound as long as the compound has properties of generating heat by itself, which is necessary for the above described ammonia borane 12 to start the thermal decomposition when a small amount of heat has been given to the heat mix 14 from the outside.

The fuel pellet 10 formed of such an ammonia borane 12 and a heat mix 14 has preferably a diameter of 3 mm to 10 mm and the whole height of approximately 3 mm to 10 mm, when it is considered to be used for portable information devices. It is experimentally confirmed that this fuel pellet 10 generates hydrogen in the highest yield when a ratio of the ammonia borane 12 and the heat mix 14 is set at approximately 4:1 to 5:1 by a mass ratio.

The fuel pellet body 16 according to the first embodiment of the present invention is constructed by doubly winding an aluminum foil 18 having the thickness of 0.01 mm around the outer periphery of such a fuel pellet 10, as is illustrated in FIG. 1B. This aluminum foil 18 has such a heat-keeping function as not to release a heat which the above described heat mix 14 generates by the heating of an electric heater that will be described later, and a heat generated when the above described ammonia borane 12 generates hydrogen, to the outside, and hold the heats in the periphery of the fuel pellet 10. As for the size of the fuel pellet 10, the diameter is 3 mm to 10 mm and the whole height is approximately 3 mm to 10 mm as was described above, but the fuel pellet of this degree of size does not have such a large heating value. Accordingly, if the heat escapes to the outside of the fuel pellet 10, hydrogen is not sufficiently generated from the fuel pellet 10. The aluminum foil 18 is a heat-keeping material for preventing the phenomenon.

According to the experiment by the inventor, an effect that this aluminum foil 18 exerts on a yield of hydrogen generation will be described below.

In the case of no aluminum foil: 12.64 mass %

In the case of one turn of aluminum foil: 13.75 mass %

In the case of two turns of aluminum foil: 14.41 mass %

In the case of three turns of aluminum foil: 14.51 mass %

It is understood that when the aluminum foil 18 is wound by two or more turns, the yield of the heat generation enhances as was described above.

It is desirable that the hydrogen generator for portable information devices is used in a state of having lowered the internal pressure of the hydrogen generator as much as possible, for the purpose of securing the safety and reducing the manufacturing cost as much as possible. In order to lower the internal pressure, the amount of hydrogen to be generated from one fuel pellet 10 needs to be reduced, and as a result, the size of one fuel pellet 10 is reduced. As the fuel pellet 10 becomes small, the generated heat becomes small. Accordingly, such a heat-keeping mechanism becomes necessary because it becomes essential not to release the heat to the outside.

The above described fuel pellet body 16 was structured so that only aluminum foil 18 was wound around the fuel pellet 10, but the case also shows an equivalent or more effect in which a material having a foam-shaped heat insulation material such as urethane sandwiched between the aluminum foils 18 has been used.

Next, a hydrogen generator which uses the above described fuel pellet body 16 will be described below.

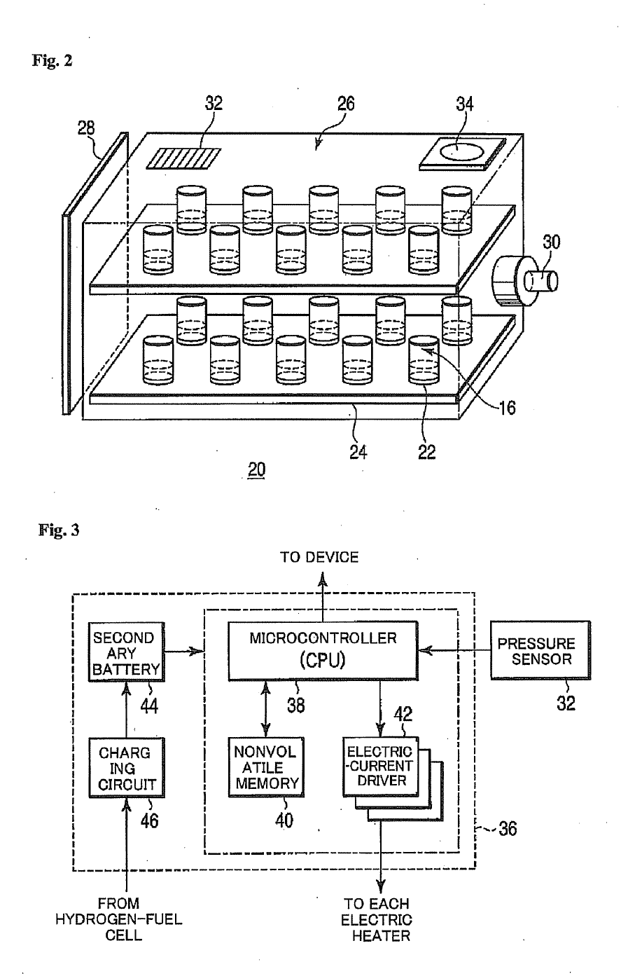

As is illustrated in FIG. 2, a hydrogen generator 20 according to the first embodiment of the present invention includes a plurality of electric heaters 22 including a heat-generating resistor or the like for heating the above described fuel pellet body 16 in the first stage. The plurality of the electric heaters 22 are aligned and arranged at a suitable space on the surface of a plate-shaped member 24 which is a fuel-pellet-holding unit, and each fuel pellet body 16 is arranged on each electric heater 22. The arrangement space between the above described electric heaters 22 is such a space that a heat generated in one fuel pellet body 16 is not transmitted to the adjacent fuel pellet body 16.

A case 26 of the hydrogen generator 20 is formed of a pressure-resistant container because hydrogen generates in the inner part thereof. On one face of this case 26, an electric substrate 28 is provided in which a controller is mounted for controlling the operation of the hydrogen generator 20. The detail of this controller will be described later. This controller supplies an electric power to each electric heater 22 in the hydrogen generator 20 (though the power supply line is not described in FIG. 2). A hydrogen liberation port 30 is provided on another face of the case 26, for instance, on the surface opposing to the above described electric substrate 28. A carbon filter which absorbs impurities except hydrogen is built in the inlet of the hydrogen liberation port 30, though the carbon filter is not shown in the figure. To this hydrogen liberation port 30, a stop valve (not shown) is externally attached which can be opened and closed from the outside. Furthermore, on one face of the case 26, for instance, on the upper surface, a diaphragm type pressure sensor 32 is provided which senses the pressure in the inside of the hydrogen generator 20, and the output of the pressure sensor 32 is connected to the controller on the above described electric substrate 28 (though the connection line is not described in FIG. 2). On this face, a rupture disk 34 is also provided. This rupture disk 34 is a commercially available component which is structured so as to be ruptured when the pressure applied to the rupture disk 34 becomes a predetermined pressure or higher. The rupture disk 34 is a safety device for preventing the hydrogen generator 20 from falling into a dangerous state such as explosion, by such a mechanism that this rupture disk 34 is ruptured before the internal pressure of the case 26 which is a pressure-resistant container exceeds the maximum pressure resistance due to some abnormal operation. This rupture disk 34 may be a mechanical valve such as a Pressure Relief Valve (PRV).

In the hydrogen generator 20 having such a structure, the fuel pellet body 16 is arranged on the above described plate-shaped member 24, and then, a thermal insulation material (not shown) of a foam shape is charged into a gap between the fuel pellet bodies 16 to fix the fuel pellet bodies 16 so that the fuel pellet bodies 16 do not move in the inside of the case 26 which is the pressure-resistant container. Alternatively, it is also acceptable to firstly charge the thermal insulation material, hollow out positions corresponding to the positions of each fuel pellet body 16 into a cylindrical shape, and store the fuel pellet bodies 16 in the positions, respectively.

In FIG. 2, 10 pieces of the fuel pellet bodies 16 are arranged on one sheet of the plate-shaped member 24, and two sets of the same plate-shaped members 24 are arranged in a stacked shape in the hydrogen generator 20. Here, the number of the fuel pellet bodies 16 and the number of the plate-shaped members 24 to be arranged in a stacked shape can be arbitrarily altered.

Next, an operation of such a hydrogen generator 20 will be described below. Suppose that a not-shown hydrogen-fuel cell is connected to the tip of the above described hydrogen liberation port 30, and that the externally attached stop valve is opened.

A controller in the above described electric substrate 28 selects one of the electric heaters 22, and applies a predetermined voltage to the electric heater 22 for a fixed period of time. Thereby, the electric heater 22 generates heat, the heat mix 14 of the fuel pellet 10 of the corresponding fuel pellet body 16 is heated, and the ammonia borane 12 of the fuel pellet 10 is heated by the heat to generate hydrogen. At this time, the above described heat mix 14 also generates hydrogen though the amount is small. The generated hydrogen passes through the carbon filter built in the inlet of the above described hydrogen liberation port 30, and is emitted from the hydrogen liberation port 30.

The operating sequence of the hydrogen generation in this embodiment will be described below.

As is illustrated in FIG. 3, the controller 36 which is mounted on the above described electric substrate 28 includes a microcontroller 38, a nonvolatile memory 40, an electric-current driver 42, a secondary battery 44 and a charging circuit 46.

Here, the above described microcontroller 38 is a device which controls the whole operation of this hydrogen generator 20, and includes one chip microcomputer which integrally has functions such as a CPU, a memory and input/output ports. The above described nonvolatile memory 40 is a device that records a usage state of the above described fuel pellet 10, and is a memory which can be electrically rewritten such as an EEPROM and a flash memory. The above described electric-current driver 42 is a device for providing an electric current in the above described electric heater 22 which is arranged in the lower side of the above described fuel pellet 10 so as to raise the temperature of the above described fuel pellet 10, and is provided for each electric heater 22. The above described secondary battery 44 is a device for supplying power to the controller 36, and is constituted by a lithium ion battery or a nickel hydrogen battery. The above described charging circuit 46 is a device for charging the above described secondary battery 44 by an electric power to be supplied from the hydrogen-fuel cell to which the present hydrogen generator is connected.

In FIG. 3, a portion surrounded by a dashed dotted line is an electronic circuit to which the above described secondary battery 44 supplies power, and a portion surrounded by a dashed line is a controller 36.

The above described nonvolatile memory 40 is configured so as to be capable of being freely read/written by the above described microcontroller 38 and assigned such that the usage state of each fuel pellet 10 is recorded in a memory address corresponding to the fuel pellet 10 by 1 to 1. Accordingly, by specifying one address of the above described nonvolatile memory 40, the microcontroller 38 can set the usage state of the fuel pellet 10 corresponding to the address and can check the usage state thereof. Examples of showing the usage state of the above described nonvolatile memory 40 include such a case that a value of FFH by a hexadecimal number in the memory shows that the fuel pellet 10 is unused, a value of 80H in the memory shows that the fuel pellet 10 is already used, and a value of 00H in the memory shows that the fuel pellet 10 is not mounted thereon. When the microcontroller 38 looks for the unused fuel pellet 10, the microcontroller 38 may scan the content of the nonvolatile memory 40 and look for the fuel pellet 10 of which the value is FFH.

Because the nonvolatile memory 40 is thus employed as a memory for recording a state of the fuel pellet 10, the microcontroller 38 can know which fuel pellet 10 is unused, even when the present hydrogen generator 20 is removed from the hydrogen-fuel cell in a state in which all of the fuel pellets 10 are not used up and is connected to another hydrogen-fuel cell, which is efficient.

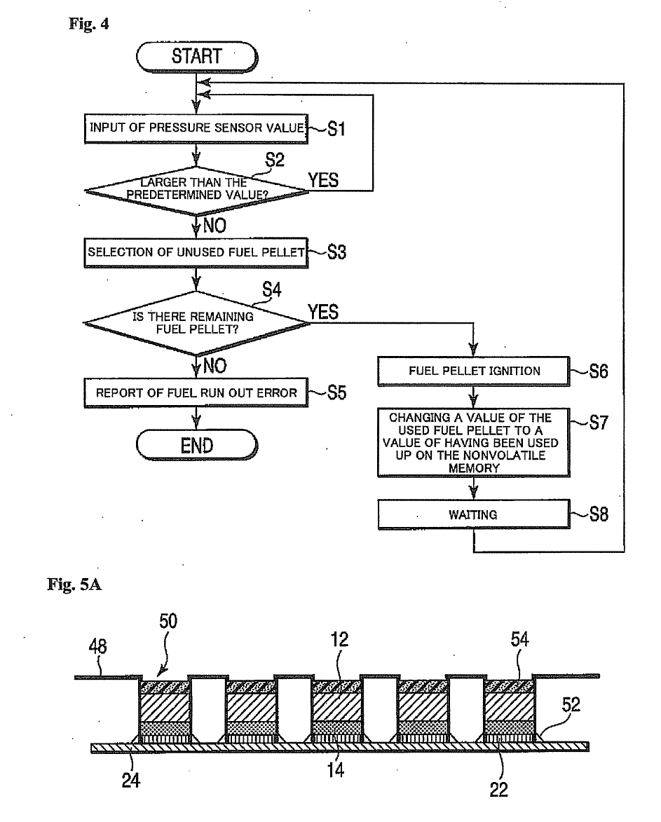

Next, an operating sequence of the above described microcontroller 38 (the CPU in the microcontroller) will be described below with reference to FIG. 4.

Firstly, the microcontroller 38 inputs a value of the above described pressure sensor 32 (Step S1). At this time, it is also possible for the microcontroller 38 to input the values of the pressure sensor 32 more than once and adopting the average value, so that the influence of noise can be reduced.

Next, the microcontroller 38 determines whether the above described input value of the pressure sensor 32 is larger than the predetermined value or not (Step S2). This predetermined value is a limit value of the amount of hydrogen, by which the hydrogen-fuel cell to which the present hydrogen generator 20 is connected can continuously generate electricity. In other words, when the hydrogen pressure in the inside of the hydrogen generator 20 becomes smaller than this predetermined value, the hydrogen-fuel cell cannot continuously generate electricity as long as hydrogen is not newly generated.

On the other hand, when hydrogen is generated from an ammonia borane 12, the yield of hydrogen generation is affected by an initial pressure of the periphery at the time when the ammonia borane 12 is heated. It was found from results of experiments carried out by the inventor that when the fuel pellet 10 of each fuel pellet body 16 was heated to generate hydrogen, the yield of the hydrogen generation was higher when the pressure in the periphery was 5 atmospheres (500,000 Pascal) or higher, and when the pressure was 10 atmospheres or more, the yield of the hydrogen generation did not increase so much. Accordingly, it is desirable to set the above described predetermined value at 5 atmospheres (500,000 Pascal) or more and a value not exceeding the maximum pressure resistance (10 atmospheres (1,000,000 Pascal)) of the hydrogen generator 20.

In the above described step S2, when it has been determined that the value of the above described pressure sensor 32 is larger than the predetermined value, the microcontroller 38 returns to a processing of inputting the value of the pressure sensor 32 of the above described step S1.

On the other hand, when it has been determined that the value of the above described pressure sensor 32 is smaller than the predetermined value in the above described step S2, the microcontroller 38 scans the content of the nonvolatile memory 40, and searches for an unused fuel pellet 10 (Step S3). The scanning operation for the nonvolatile memory 40 may be conducted only in the first time and omitted after the first time, by recording the scan result into a predetermined address of the nonvolatile memory 40. After that, the microcontroller 38 determines whether the unused fuel pellet 10 exists or not (Step S4).

Here, when it has been determined that all of the fuel pellets 10 are used and there is no unused fuel pellet 10, the microcontroller 38 reports a fuel run out error to a higher level device which uses this hydrogen generator 20 (Step S5). Incidentally, here, the fuel run out error is programmed so as to be reported to the higher level device when there is no unused fuel pellet 10, but a warning that the amount of a remaining fuel is little may be programmed so as to be reported when the number of the unused fuel pellet 10 becomes less.

In addition, when it has been determined that there is the unused fuel pellet 10 in the above described step S4, the microcontroller 38 drives an electric-current driver 42 corresponding to the selected unused fuel pellet 10, provides a predetermined electric current in the electric heater 22 of the fuel pellet 10, and starts an operation of generating hydrogen from the corresponding fuel pellet 10 (Step S6). Next, a value of the nonvolatile memory 40 in a place corresponding to the used fuel pellet 10 is rewritten to a value of having been used up from a value of being unused (Step S7). Incidentally, here, the operation of generating hydrogen from the fuel pellet 10 was started, but because some period of time is needed before hydrogen is actually generated, the operation waits for a fixed period of time (Step S8) and returns to the processing of the above described step S1.

When hydrogen is intermittently generated from a little amount of the ammonia borane 12 in the case 26 which is a pressure-resistant reactor, the internal pressure of the pressure-resistant reactor increases, and when the hydrogen is used for a fuel cell, the internal pressure decreases. A hydrogen-generating reaction is conducted at a fast speed, and hydrogen is generated at a faster speed than a speed required for power generation by the hydrogen-fuel cell. For this reason, when it has been detected by using the pressure sensor 32 that the internal pressure has decreased to a value lower than a previously determined pressure value, the hydrogen generation of another ammonia borane 12 is started, and thereby the hydrogen-fuel cell can continuously generate electricity.

As was described above, the fuel pellet body 16 according to the present first embodiment is formed of the fuel pellet 10 where perimeter is surrounded by the aluminum foil 18, thereby keeps the initial internal pressure in hydrogen generation at the optimum value at which the yield of the hydrogen generation becomes maximal when the hydrogen is generated from the hydrogen generating compound in the hydrogen generator 20, can keep the heat generated from the hydrogen generating compound itself without releasing the heat to the periphery, and accordingly can enhance the yield of the hydrogen generation.

Accordingly, it becomes possible to efficiently generate hydrogen from the hydrogen generating compound even though the hydrogen generator is small, and the present invention can provide a hydrogen generator which can enhance the electrical power output per unit volume of a connected hydrogen-fuel cell, and a fuel pellet body to be used for the same.

### Second Embodiment

Next, the second embodiment of the present invention will be described below.

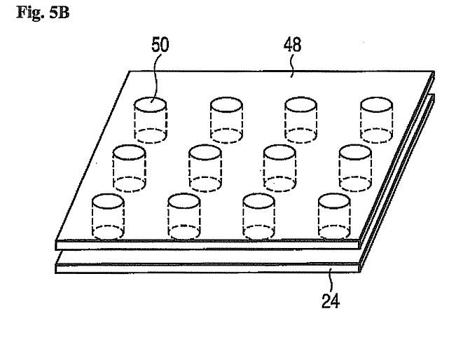

FIG. 5A is a view illustrating a sectional structure of a fuel-pellet-holding unit of a hydrogen generator 20 according to the second embodiment of the present invention. Here, the elements having the same function as in the first embodiment are denoted by the same reference numerals. In addition, note that the hatching put on the section is drawn for clarifying a difference between each member and is not intended to show such a material as is determined in Standards for drawings of The United States Patent and Trademark Office, for instance. FIG. 5B is a perspective view of the whole pellet-holding unit when overlooked from an obliquely upper part. This FIG. 5B illustrates a fuel-pellet-holding unit on which four pieces of the fuel pellet 10 as illustrated in FIG. 1A are transversely aligned and the three rows of them are longitudinally aligned, and the case in which the fuel-pellet-holding unit is structured so that 12 pieces in total of the fuel pellets 10 can be stored.

This fuel-pellet-holding unit is stored in the case 26 which is the pressure-resistant container as shown in the above described first embodiment, the controller 36 mounted on the electric substrate 28 controls the operation, and the generated hydrogen exits to the outside from the hydrogen liberation port 30.

As is illustrated in FIG. 5A, the fuel-pellet-holding unit is formed by pressing an aluminum sheet 48 having a thickness of approximately 0.2 mm with a die to form a recess 50 having such a size that a cylindrical fuel pellet 10 can be inserted therein and cutting the bottom part of the recess 50. This recess 50 is formed so as to become a slightly larger than that of the fuel pellet 10 to be inserted in the recess. When the diameter of the fuel pellet 10 is 5 mm and the height is 8 mm, for instance, the diameter of the recess 50 shall be 5.2 mm and the depth shall be 8.5 mm.

The electric heater 22 is arranged in a predetermined position on the above described plate-shaped member 24. Each electric heater 22 is structured so as to receive an electric power supplied from the electric substrate 28 and heat the heat mix 14 of the fuel pellet 10 inserted in the recess 50 of the above described aluminum sheet 48, similarly to that in the first embodiment. The recess 50 to be formed in the aluminum sheet 48 is prepared so that the position matches the position of the electric heater 22 on this plate-shaped member 24.

The aluminum sheet 48 having the above described recess 50 prepared therein is mounted on the above described plate-shaped member 24, is positioned so that the electric heaters 22 match the respective recesses 50, and the gap between the recess 50 of the aluminum sheet 48 and the plate-shaped member 24 is filled with a sealing material 52 so that generated hydrogen does not leak. Then, the heat mix 14 and the ammonia borane 12 which have been pressed so as to have a previously determined size are inserted in each recess 50, in the order. The heat mix 14 has the diameter of 5 mm and the height of 1.6 mm, and the ammonia borane 12 has the diameter of 5 mm and the height of 6.4 mm, for instance. On the ammonia borane 12, a sponge 54 which passes hydrogen therethrough is placed which has been cut so as to be slightly larger than the diameter of the recess 50, in order to reduce the movement of the fuel pellet 10 in hydrogen generation.

The ammonia borane 12 is a solid, but when having been heated to approximately 100° C., becomes a liquid state once, and then generates hydrogen. At this time, the ammonia borane 12 forms a mixture state in which one part is solid and one part is liquid, depending on how the heat has been applied, and gaseous hydrogen is generated from the mixture state of the ammonia borane 12. Accordingly, the fuel pellet 10 does not stand still there, but may move in a direction which is not regulated by a wall or the like. Then, the heat generated in the heat mix 14 is not sufficiently conducted, which consequently decreases the yield of the hydrogen generation. However, according to the present embodiment, the movement of the fuel pellet 10 can be prevented by the structure having the above described recess 50 and the sponge 54, which can stabilize the yield of the hydrogen generation.

Thus, the hydrogen generator in the present embodiment is arranged so as to insert the heat mix 14 and the ammonia borane 12 in a cylindrical recess 50 which has been previously formed in the aluminum sheet 48, in place of winding the fuel pellet 10 with the aluminum foil 18 as in the above described first embodiment, and accordingly can greatly reduce an effort of arranging the plurality of the fuel pellets 10 in a matrix form on the plate-shaped member 24.

The hydrogen generator in the present embodiment also controls the hydrogen generation in each fuel pellet 10, by detecting the internal pressure with the same constitution/sequence as in the above described first embodiment. The operation is the same as in the above described first embodiment, so, the description will be omitted.

The present invention was described with reference to the embodiments, but is not limited to the above described embodiments, and it is natural that various modifications and applications can be made within a range of the scope of the present invention.

1. A hydrogen generator for generating hydrogen from a hydrogen generating compound by a chemical reaction, characterized in that it comprises:
a plurality of fuel pellets including the hydrogen generating compound;
a pressure-resistant container for storing the plurality of fuel pellets; and
a controller for controlling hydrogen generation from the fuel pellets, wherein
the periphery of the fuel pellet is enclosed with a member including a thin plate of metal aluminum on its surface.

2. The hydrogen generator according to claim 1, wherein a pressure inside the pressure-resistant container when the hydrogen generation from the fuel pellet is started is controlled to be between 500,000 Pa and 1,000,000 Pa.

3. The hydrogen generator according to claim 1, wherein the member including a thin plate of metal aluminum on its surface is an aluminum foil, the aluminum foil being wrapped at least two turns around the fuel pellet.

4. The hydrogen generator according to claim 1, wherein the member including a thin plate of metal aluminum on its surface is an aluminum sheet having a depression which is of size enough to receive each of the fuel pellets and whose bottom portion is cut away.

5. A fuel pellet body stored in a pressure-resistant container in a hydrogen generator for generating hydrogen from a hydrogen generating compound by a chemical reaction, comprising:
a hydrogen generating compound compacted into a cylindrical shape; and
a member including a thin plate of metal aluminum on its surface to enclose the periphery of the hydrogen generating compound.

6. A hydrogen generator for generating hydrogen from a hydrogen generating compound by a chemical reaction, characterized in that it comprises:
a plurality of fuel pellets including the hydrogen generating compound;
a pressure-resistant container for storing the plurality of fuel pellets; and
a controller for controlling hydrogen generation from the fuel pellets;
wherein the controller comprises a non-volatile memory that is arranged to record the usage state of each pellet, the controller being arranged to change the value in the non-volatile memory for each pellet, after it has been ignited, to a value that indicates that it is used up.

7. The hydrogen generator as claimed in claim 6, wherein the controller is arranged when hydrogen is required to (i) search for an unused pellet and (ii) determine whether or not an unused pellet exists and, if so (iii) to ignite the pellet.

8. The hydrogen generator as claimed in claim 6, wherein the controller is arranged to report a fuel run out error when all the fuel pellets are used up.

9. The hydrogen generator as claimed in claim 6, wherein the controller is arranged to report a warning when the number of unused pellets becomes low.

10. The hydrogen generator as claimed in claim 6, wherein the non-volatile memory is arranged to record the following states for each pellet: unused and used and unmounted.
